(19) United States
(12) Patent Application Publication
(10) Pub. No.: US 2014/0332364 A1
(43) Pub. Date: Nov. 13, 2014

(54) MODULAR DISTILLATION UNIT AND ETHANOL SEPARATING APPARATUS

(71) Applicant: JA Energy, Inc., Las Vegas, NV (US)

(72) Inventors: James Derrel Lusk, Las Vegas, NV (US); Gene Shane, Las Vegas, NV (US); Eric Hewlett, Las Vegas, NV (US)

(73) Assignee: JA Energy, Inc., Las Vegas, NV (US)

(21) Appl. No.: 14/272,358

(22) Filed: May 7, 2014

Related U.S. Application Data
(60) Provisional application No. 61/820,666, filed on May 7, 2013.
(60) Provisional application No. 61/894,355, filed on Oct. 22, 2013.
(60) Provisional application No. 61/909,919, filed on Nov. 27, 2013.

(51) Int. Cl. C12F 3/10; B01D 3/00; C12G 3/12

(52) U.S. Cl. CPC C12F 3/10; C12G 3/12; B01D 3/003
USPC 202/152; 99/276

(57) ABSTRACT

Modular ethanol distillation units housed within one or two shipping containers and ethanol distillation units that include an evaporative plate located inside a distillation tank to promote evaporation of the ethanol. Modular distillation units housed within shipping containers are easily transported and set up in remote locations where suitable feed stocks are available or can be cultivated to supply the unit and to distill ethanol for local use or export. Distillation units include feedstock storage tanks, a mixing chamber, fermentation tanks, and a distillation system/tank, which can all be located within one or two shipping containers. Evaporative plates can include holes therethrough, dimples, troughs, or a combination thereof, and holes can be located within dimples.

### RELATED PATENT APPLICATIONS

This patent application claims priority to Provisional Patent Application No. 61/820,666, filed on May 7, 2013, and to Provisional Patent Application No. 61/894,355, filed on Oct. 22, 2013, both titled: Method of Producing Fuel and Modular Distillation Unit, and to Provisional Patent Application No. 61/909,919, filed on Nov. 27, 2013, titled: Electrical Generation System, Method of Producing Electrical Energy, and Method of Manufacturing an Electrical Generation System, which all have at least one inventor in common with the current patent application and the same assignee. The contents of these priority provisional patent applications are incorporated herein by reference. Certain terms, however, may be used differently.

### FIELD OF THE INVENTION

This invention relates to ethanol distillation units and systems and methods for separating ethanol from water in an ethanol distillation unit.

### BACKGROUND OF THE INVENTION

Ethanol, also called ethyl alcohol, or beverage alcohol, is a type of alcohol with the structural formula CH₃CH₂OH, often abbreviated as C₂H₅OH or C₂H₆O, that can be used as a fuel, including as a substitute or additive to gasoline, and can be used in internal combustion engines, among other things. Ethanol can be distilled from agricultural products through a sugar and starch fermentation process. In addition, since carbon is removed from the atmosphere when the agricultural products are grown, the production and combustion of ethanol can be a carbon neutral process. Consequently, the use of ethanol can avoid contributing to global warming, especially in comparison with combustion of fossil fuels. In addition, production of ethanol can be a renewable process, in comparison with the limited nature of fossil fuels.

Ethanol distillation units have been built and used before, but have required special facilities and have been difficult to deliver and set up in remote locations, for example, where agricultural products are available and ethanol is needed. In addition ethanol distillation units have been slow to separate ethanol from water in the distillation process. As a result, needs or potential for benefit or improvement exist for ethanol distillation units that do not require special facilities where they are used, that are easy to deliver and set up in a remote location, for example, where agricultural products are available and ethanol is needed, and that are reasonably well protected in such remote locations. In addition, needs or potential for benefit or improvement exist for ethanol distillation units that separate ethanol from water more quickly in the distillation process. Further, needs or potential for benefit or improvement exist for methods of distilling ethanol and methods of providing ethanol distillation units. Other needs or potential for benefit or improvement may also be described herein or known in the biofuels or ethanol distillation industries, for example. Room for improvement exists over the prior art in these and other areas that may be apparent to a person of ordinary skill in the art having studied this document.

### BRIEF DESCRIPTION OF THE DRAWINGS

FIG. 1 is a top view block diagram illustrating, among other things, an example of a modular ethanol distillation unit located in a shipping container;

FIG. 2 is a top view illustrating an example of an evaporative plate that is part of the distillation system within the modular ethanol distillation unit of FIG. 1;

FIG. 3 is a detail partial top view illustrating part of the evaporative plate of FIG. 2 that is part of the distillation system within the modular ethanol distillation unit of FIG. 1;

FIG. 4 is a detail partial end view illustrating the part of the evaporative plate of FIG. 3 that is part of the distillation system within the modular ethanol distillation unit of FIG. 1;

FIG. 5 is a front view of a distillation tank which can be part of the modular ethanol distillation unit of FIG. 1;

FIG. 6 is a side or end view of the distillation tank of FIG. 5;

FIG. 7 is a front view of the distillation tank of FIGS. 5-6, also showing cracking towers mounted on the distillation tank; and

FIG. 8 is a side or end view of the distillation tank and cracking towers of FIG. 7.

These drawings illustrate, among other things, examples of certain aspects of particular embodiments of the invention. Other embodiments may differ. For example, in some embodiments, components or acts may be omitted, or acts may be performed in a different order. Various embodiments may include aspects shown in the drawings, described in the specification, shown or described in other documents that are incorporated by reference, known in the art, or a combination thereof, as examples.

### SUMMARY OF PARTICULAR EMBODIMENTS OF THE INVENTION

This invention provides, among other things, ethanol distillation units that do not require special facilities and that are relatively easy to deliver and set up in remote locations, for example, where agricultural products are available and ethanol is needed. In addition, this invention provides ethanol distillation units that separate ethanol from water in the distillation process more quickly or more effectively than certain prior art alternatives. Furthermore, this invention provides various methods of distilling ethanol and methods of providing ethanol distillation units. Various embodiments provide, for example, as an object or benefit, that they partially or fully address or satisfy one or more of the needs, potential areas for benefit, or opportunities for improvement described herein, or known in the art, as examples. Certain embodiments provide, for instance, modular ethanol distillation units, for example, housed in a shipping container, that are simple to deliver and set up in remote locations, for example, in agricultural areas, and that provide reasonable protection to the distillation units and equipment in such remote locations. In addition, particular embodiments provide, for example, ethanol distillation units that separate ethanol from water in the distillation process more quickly or effectively through the addition of an evaporative plate inside the distillation unit that increases the surface area of the ethanol and water mixture to improve the evaporation rate of the ethanol.

In various embodiments, ethanol is distilled from agricultural products through a sugar and starch fermentation process. In addition, since carbon is removed from the atmosphere when the agricultural products are grown, the production and combustion of ethanol can be a carbon neutral process. Consequently, the use of ethanol can avoid contributing to global warming, especially in comparison with combustion of fossil fuels. In addition, production of ethanol can be a renewable process, in comparison, for instance, with the limited nature of fossil fuels.

Specific embodiments of the invention provide various modular distillation unit. Such a unit can include, for example, one or more shipping containers, one or more storage tanks, a mixing chamber, a fermentation system, and a distillation system. In various embodiments, the one or more storage tanks are located inside the one or more shipping containers and are configured to a hold feedstock. Further, in a number of embodiments, the mixing chamber is located inside the one or more shipping containers and is coupled to the one or more storage tanks. In various embodiments, the mixing chamber is configured to mix the feedstock and water to create a feeder mixture, for example, with a predetermined ratio of the feedstock and the water. Even further, in a number of embodiments, the fermentation system is also located inside the one or more shipping containers and is configured to ferment the feeder mixture. In a number of embodiments, the fermentation system includes, for example, one or more fermentation tanks. Still further, in various embodiments, the distillation system is also located inside the one or more shipping containers and is coupled to the fermentation system and is configured to distill ethanol from an output of the fermentation system.

In some embodiments, the distillation system includes a distillation tank and an evaporative plate located inside the distillation tank, and a mixture of ethanol and water is distributed over the evaporative plate. Further, in particular embodiments, the evaporative plate includes multiple holes therethrough distributed over the evaporative plate, and the mixture of ethanol and water flows through the holes through the evaporative plate. Even further, in some embodiments, the evaporative plate includes multiple dimples, and each of the multiple holes is located in one of the dimples. Still further, in particular embodiments, the modular distillation unit includes a pasteurization system, for example, located inside the one or more shipping containers, and configured, for instance, to be used to clean the fermentation system.

In certain embodiments, the modular distillation unit includes, for example, one or more installation rails coupled to at least one of the one or more shipping containers and removably couplable to the one or more storage tanks, for instance, to couple the one or more storage tanks to the at least one of the one or more shipping containers. Further, in particular embodiments, each of the one or more shipping containers is a 40 feet long by 8 feet wide steel shipping container. Still further, in some embodiments, the mixing chamber includes a metal mixing medium located inside the mixing chamber. Even further, in some embodiments, the metal mixing medium includes at least one of a stainless steel scrubber, steel wool, copper wool, brass wool or another metallic wool or scrubber.

Other specific embodiments include various ethanol distillation units that include, for example, a distillation tank where the ethanol is separated from water, and an evaporative plate located inside the distillation tank. In a number of such embodiments, a mixture of the ethanol and the water is distributed over the evaporative plate. In some such embodiments, for example, the evaporative plate includes multiple holes therethrough distributed over the evaporative plate, and the mixture of the ethanol and the water flows through the holes through the evaporative plate. Further, in certain embodiments, the evaporative plate includes at least one centrally located opening through the evaporative plate and ethanol vapor flows through the at least one centrally located opening through the evaporative plate. Still further, in particular embodiments, the at least one centrally located opening has a cross sectional area that is at least 10 times greater than a combined cross sectional area of the multiple holes. Even further, in certain embodiments, the evaporative plate includes multiple dimples and each of the multiple holes is located in one of the dimples.

In some embodiments, the ethanol distillation unit is located and operated within a shipping container. Further, in some embodiments, the ethanol distillation unit further includes, for example, at least one feedstock storage tank, a mixing chamber that mixes the feedstock and water to create a feeder mixture with a predetermined ratio of the feedstock and the water, and a fermentation system that ferments the feeder mixture. In a number of embodiments, the fermentation system includes, for example, at least one fermentation tank, and the fermentation system outputs the mixture of the ethanol and the water to the distillation tank where the ethanol is separated from water. Moreover, in some embodiments, the ethanol distillation unit further includes, for example, a pasteurization system that cleans the fermentation system. Furthermore, in some embodiments, the evaporative plate includes multiple troughs and the mixture of the ethanol and the water flows through the troughs across the evaporative plate. In addition, various other embodiments of the invention are also described herein, and other benefits of certain embodiments may be apparent to a person of ordinary skill in the art.

### DETAILED DESCRIPTION OF EXAMPLES OF EMBODIMENTS

A number of embodiments of the subject matter described herein include a Modular Distillation Unit (MDU), that can include, for example, an array of components, storage tanks, equipment, controls, electrical devices, or a combination thereof, installed, for example, in a single or multiple (e.g., reused) (e.g., 40 feet long by 8 feet wide steel) shipping container. In some embodiments, multiple MDUs provide a decentralized production of ethanol. In certain embodiments, one MDU can produce, for example, approximately 1,500 gallons per week, or 210 gallons a day, of ethanol through a process of fermentation and distillation.

In different applications, the ethanol can be used as heating fuel, used as a gasoline additive, mixed with vegetable oil to create a form of bio-diesel, or sold to produce revenue, as examples. The MDU can also produce, in some embodiments, approximately 560 gallons, for example, of stillage (e.g., residual water) a day. The stillage can contain multiple nutrients, in a number of embodiments, and can be used to water crops, enhance the efficiencies of anaerobic digesters, or as a growth medium in hydroponic greenhouses, as examples. Use of multiple fermentation tanks, in some embodiments, allows for a daily harvest of ethanol and stillage. The MDU also can create, in some embodiments, approximately 1650 pounds per day, for example, of carbon dioxide, that can be diverted into a greenhouse, for instance, to significantly increase crop production. In a number of embodiments, a complete modular turn-key system, for example, can be enclosed in a single shipping container, in two shipping containers, or in another number of shipping containers, that can be shipped to and operated in many different parts of the world.

In a number of embodiments, the system utilizes one or several flat plate heat exchangers, for example, to maintain desired temperatures of system fluids. Further, in various embodiments, the MDU can be manufactured complete with state of the art, for example, direct digital controls (DDC), for instance, with a LED human interface panel. Even further, in some embodiments, the modular distillation system can be coupled to other modular systems, for instance, to produce electricity. For example, in some embodiments, the MDU described herein can be combined with a Modular Electrical Generation (MEG) unit. The MEG unit can include, in different embodiments, one, two, three, four, or more different types of electrical generation engines, for instance, that are tied together to generate, for example, approximately 342 MWh (megawatt hours) of electrical power per year. In particular embodiments, the first engine in a series of three is a gas turbine engine fueled by the ethanol provided by the MDU. In some embodiments, all (e.g., three) of the engines are fueled by the ethanol provided by the MDU.

In another example, the MDU described herein is combined with a solar concentrator system. The solar concentrator system can utilizes a fluid carrier tube, tracking Fresnel lenses, and thermal electrical generators producing heat to run a sterling engine to generate power, for example. In some embodiments, the solar system is (e.g., also or instead) used to condense the syrup (e.g., feedstock for the MDU) from local crops.

In some embodiments, the MDU can be combined with a hydroponic greenhouse, for example, to improve crop production and/or a thermophilic anaerobic digester. In certain embodiments, pairing an MDU with a hydroponic greenhouse can triple tomato production, for instance, to 12 pounds per square foot per year. Commensurate increases can occur for other crops as well. Thus, in particular embodiments, an urban installation of an MDU paired with an 11,000 square foot greenhouse, for instance, could sell 22 to 66 tons of food per year.

In some embodiments, a harvester can extract juice from sugar-rich crops, a condenser can reduce crop juice to syrup for storage, the MDU can produce ethanol from the sugar syrup, and the anaerobic digester can process pulp from the juice extraction into methane gas and organic fertilizer. In a number of embodiments, the system can be provided with a hydronic chamber, for example, that efficiently mixes feedstock product such as blackstrap molasses and heated reverse osmosis water. Further, in some embodiments, the MDU can be provided with built-in safety features.

In some embodiments, a Modular Distillation Unit (MDU) can include an array of components, storage tanks, equipment, controls, and electrical components, for example, installed in two (e.g., reused) shipping containers and provide decentralized production of ethanol. In other examples, the MDU can be contained in three or more shipping units. IN certain embodiments, the MDU can produce, for example, approximately 1,500 gallons per week of ethanol through a process of fermentation and distillation. These embodiments can generally work the same or similar to the previously described MDU and provide the user with benefits of the previous embodiment. In this example, the MDU can include seven tanks, for example, instead of three in the previous described embodiment. Other embodiments may have a different number of tanks, such as 1, 2, 4, 5, 6, 8, 10, 11, 12, 13, 14, 15, 16, 18, 20, or more, as examples.

In a dual shipping container configuration, for example, the MDU system can use two 40 feet long by 8 feet wide boxes or shipping containers to house tanks and equipment. The boxes or shipping containers can be to be installed side by side, for example, with a 36 inches wide by 6 feet to 8 feet tall opening or coupling between the two boxes or shipping containers. In some embodiments, modular piping, valves, and piping racks accommodate quicker assembly of the MDUs. Individual racks can be assembled with quick connect hoses, for example. In certain embodiments, control valves and pumps are moved into place within the MDU for quicker and easier installation. Further, in a number of embodiments, installation rails, such as steel slide rails, are provided on one side and the ceiling of each of the containers, for example. In some embodiments, modular support racks can quickly tie into the rails. With the support racks locked in place with the support rails, the racks act as tank support and lockdown mechanisms, as examples.

In a number of embodiments, the distiller is smaller (in size and volume) than the previously described embodiment and has four cracking towers instead of three. In addition, in some embodiments, the tank is provided with a copper wire mesh screen, for example, below the coil, a (e.g., copper) evaporative plate located above the coil, a (e.g., stainless steel) distribution header, or a combination thereof, as examples. In a number of embodiments, the evaporative plate improves the flow of the ethanol production from the distiller tank. In various embodiments, the evaporative plate has dimples and small, (e.g., 1/16th diameter) holes and larger openings below each of the cracking towers. Further, in some embodiments, the lid lifting handle can be folded out of the way of foot traffic when the lid is closed. Even further, the tank lid can have lockdown clamps, in some embodiments.

In some embodiments, a closed loop chilled water system is used as a cooling system. In a number of embodiments, a small (e.g., 1 ton) air cooled chiller and the closed loop can cool down the cracking towers and tower condensers with more efficiency and controllability than other alternatives. Further, in some embodiments, the system can provided cooling to the pasteurization system described below. This cooling system significantly decreases water usage, in some embodiments, compared to other alternatives.

In various embodiments, the MDU can include a pasteurization system, which ensures, in a number of embodiments, that all of the tanks are adequately free of contamination. In different embodiments, source water provided to the MDU can either flow through a flat plate heat exchanger or pass through a coil located in the stillage tank to increase the temperature of the water from, for example, 65 degrees Fahrenheit to 180 degrees Fahrenheit (e.g., at a minimum), in some embodiments. Once the water is heated, it is passed through a filtration system, in various embodiments, and then cooled back down prior to feeding the fermentation process. For tank cleaning, in a number of embodiments, a control valve is included in the pasteurization system where 180 degrees Fahrenheit water can be diverted to each of the fermentation tanks at, for example, 50 gallons at time to sanitize the tanks via rotary unions and spinning spray arms prior to the fermentation process.

In a number of embodiments, the closed loop heating system piping uses rigid, high-quality, stretchable, stainless-steel pipes (e.g., a Pro-fit® pipes of DL Products BV), which decrease assembly time and, in some embodiments, eliminate leaks due to poor workmanship. Further, in some embodiments, the closed loop cooling system can use rigid, high-quality stretchable stainless-steel pipe system. Further, for distiller distribution, in some embodiments, the MDU is equipped with, for example, a 1,000 psi pump that provided fermentation to a misting ring located within the distiller tank. In a number of embodiments, for example, a pressure feed pump and stainless steel header located at one end of the copper evaporative plate is used. In other embodiments, a low pressure circulating pump is used, and the mixture flows onto the evaporative plate, as another example.

Source water, in various embodiments, (e.g., city water or well water) can enter the MDU and be heated. In other examples, the water can be heated using other methods to a temperature such as 80 degrees Fahrenheit. In some embodiments, the primary feedstock for the unit can be black strap molasses, for example, located in a storage tank. In other embodiments, the feedstock can be sugar cane, sugar beets, Jerusalem artichokes hearts, or sorghum, as examples, or another high-sugar plant source. The molasses or other feedstock, in various embodiments, can be pumped out of the tank to the mixing chamber where it mixes with water. In certain embodiments, the water/molasses mixer component can (e.g., efficiently) allow the feedstock media, such as molasses, and hot water to mix, providing a minimal viscosity, for instance, prior to entering the fermentation tanks.

At the same time, in various embodiments, the yeast feeder system can be engaged supplying, for example, a pre-measured amount of yeast via a pump and control valves to the input of each of the fermentation tanks. Temperatures, levels and ratios of the mixture at each tank can be measured and controlled, in some embodiments, with control valves, pumps and sensors tied to the MDU Control System to achieve the desired “feed solution.” A boiler, in one example, can modulate temperature set-point and safeties upon its own controls.

The Distillation column, in some embodiments, can include a feed pump, shell and tube heat exchanger, and stripper section, as examples, where the stillage can be introduced as a vapor spray into the chamber. In a number of embodiments, the ethanol flashes to vapor and rises while the water is separated and falls to the bottom of the chamber along with any residual organics. The vapor rises, in various embodiments, into the rectifier section, where it starts the condensing process and further reduces any water content in the vapor. The ethanol vapor then flows, in a number of embodiments, into the condenser tube, for example, where the property is changed, converting the vapor to liquid ethanol.

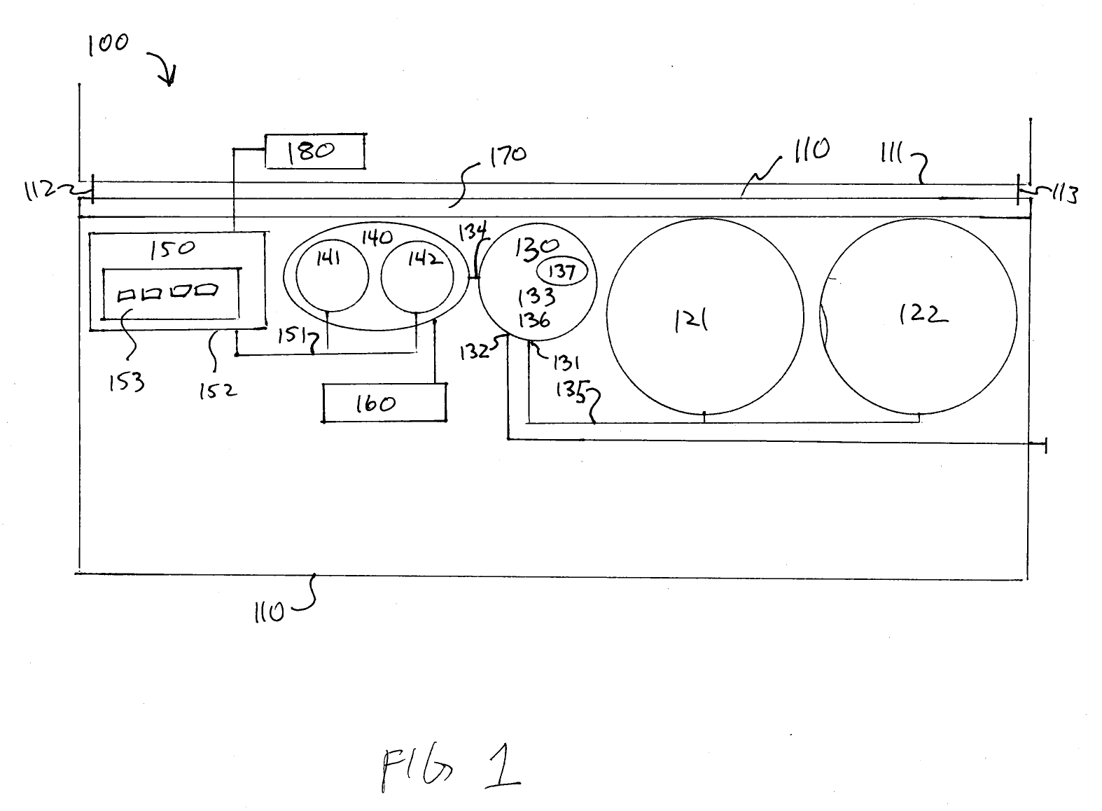

Turning now to the figures, FIG. 1 illustrates an example of a distillation unit, modular distillation unit 100, that includes shipping container 110. Different embodiments include one or more shipping containers (e.g., 110, or 110 and 111, or more). In some embodiments each of the one or more shipping containers (e.g., 110, or 110 and 111) is a 40 feet long by 8 feet wide steel shipping container, for example. In certain embodiments, the shipping container(s), or part thereof, are insulated (e.g., on the inside), ventilated, air conditioned, heated, or a combination thereof, as examples. In particular embodiments, a ground source cooling system is used, for example. Further, different embodiments include one or more storage tanks (e.g., 121 and 122) located inside the one or more shipping containers (e.g., 110, 111, or both) and configured to a hold feedstock. Two storage tanks are shown, but other embodiments have 1, 3, 4, 5, 6, 7, 8, 9, 10, or 12 storage tanks, as other examples.

Further, distillation unit 100 includes mixing chamber 130 located inside shipping container 110 and coupled (e.g., by pipe 135) to the one or more storage tanks (e.g., 121 and 122). Various pipe connections herein may contain one or more valves, a pump, unions, flanges, etc. In various embodiments, the mixing chamber is located inside the one or more shipping containers (e.g., 110 or 111). In various embodiments, the mixing chamber (e.g., 130) is configured to mix the feedstock (e.g., from tanks 121 and 122) and water to create a feeder mixture with a predetermined ratio of the feedstock and the water. Even further, in some embodiments, the mixing chamber includes a (e.g., metal) mixing medium (e.g., 137) located inside the mixing chamber (e.g., 130). Even further still, in some embodiments the mixing medium includes at least one of a stainless steel scrubber, steel wool, copper wool, brass wool or another metallic wool or scrubber, as examples.

In the embodiment illustrated, modular distillation unit 100 also includes fermentation system 140, also located inside the one or more shipping containers (e.g., shipping container 110 in the embodiment shown). In this particular embodiment, fermentation system 140 is configured to ferment the feeder mixture (e.g., from mixing chamber 130). Further, in various embodiments, the fermentation system includes one or more fermentation tanks. In this embodiment, fermentation system 140 includes fermentation tanks 141 and 142, for example. In the embodiment illustrated, two fermentation tanks are shown, but other embodiments can have 1, 3, 4, 5, 6, 7, 8, 9, 10, 11, 12, 13, 14, or 15 fermentation tanks, as other examples.

Further, in the embodiment illustrated, modular distillation unit 100 also includes distiller or distillation system 150, also located inside the one or more shipping containers (in this embodiment, shipping container 110) and coupled (e.g., by pipe 151) to fermentation system 140 and to fermentation tanks 141 and 142. In the embodiment shown, distillation system 150 is configured to distill ethanol from an output of fermentation system 140 (e.g., delivered via pipe 151). In the particular embodiment shown, distillation system 150 includes distillation tank 152 and evaporative plate 153 located inside distillation tank 152. As used herein, a plate being “located inside” a tank, means that the plate is not part of the tank. For example, as used herein, a plate being “located inside” a tank, means that the plate is not part of the top, bottom, or side walls of the tank. Further, the distillation tank (e.g., 152), in various embodiments, is fully enclosed from the atmosphere (e.g., within shipping container 110), and as used herein, a plate “located inside” a tank does not form part of the enclosure of the tank.

In the embodiment illustrated, a mixture of ethanol and water (e.g., from fermentation system 140) is distributed over evaporative plate 153 to accelerate the evaporation of the ethanol and the separation of the ethanol from the water. As used herein, a mixture being “distributed” over a plate means that the mixture contacts at least 25 percent of one surface (e.g., the top surface) of the plate. In some embodiments, however; the mixture contacts at least 10, 20, 30, 40, 50, 60, 70, 80, 90, or 95 percent of the one surface (e.g., the top surface) of the plate, as other examples. In some embodiments, the mixture of ethanol and water is sprayed onto the evaporative plate, while in other embodiments, the mixture of ethanol and water flows onto the plate as a stream, as another example. In some embodiments, the mixture of ethanol and water is delivered or distributed onto the evaporative plate with a pump, for example. Distillation system 150 and distillation plate 153 are described in more detail below with reference to other figures.

Still referring to FIG. 1, modular distillation unit 100, in the embodiment illustrated, further includes pasteurization system 160, located inside the one or more shipping containers (e.g., 110 in the embodiment illustrated). In the embodiment shown, pasteurization system 160 is configured to be used to clean fermentation system 140 (e.g., fermentation tanks 141 and 142).

Further, modular distillation unit 100 further includes installation rail 170 coupled to the inside of a wall of shipping container 110 and removably couplable to storage tanks 121 and 122 to couple the storage tanks to shipping container 110. As used herein, “removably couplable” means able to be repeatedly attached and disconnected non-destructively using only non-powered hand tools, without consuming any materials, in a manner that forms an attachment having a strength greater than the weight of the equipment involved (e.g., the tanks). Attachment with suitably sized and located fasteners, such as screws, bolts, nuts, or a combination of nuts and bolts, are examples. As used herein, welds are not considered to be “removably couplable”. Various embodiments include one or more installation rails (e.g., 170) coupled to at least one of the one or more shipping containers (e.g., 110) and removably couplable to the one or more storage tanks (e.g., 121 and 122) to couple the one or more storage tanks to the at least one of the one or more shipping containers. In the embodiment illustrated, installation rail 170 also attaches mixing chamber 130, fermentation system 140, and distillation system 150 to the wall of shipping container 110. Installation rail 170 can be strut channel, such as Unistrut, for example, and various components can be removably couplable to the installation rail 170 with fasteners, such as bolts (e.g., and nuts that can be, for example, of a type that are held within the installation rail with a spring). Some embodiments include multiple installation rails mounted in the walls, ceiling, floor, or a combination thereof, of the shipping container, for example.

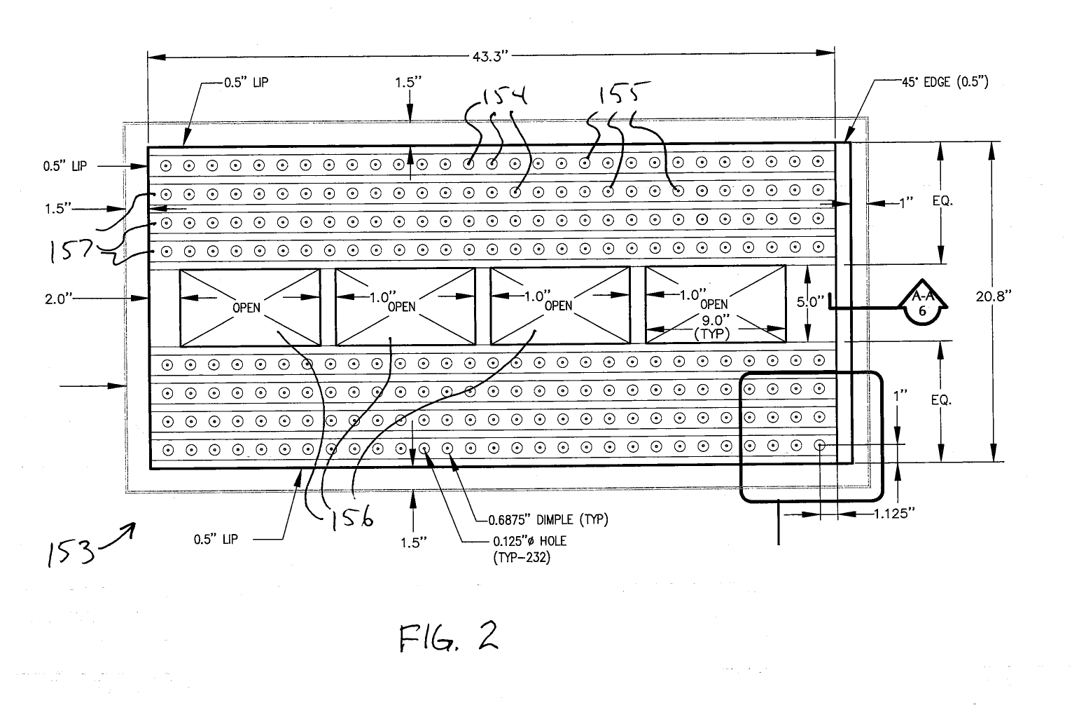

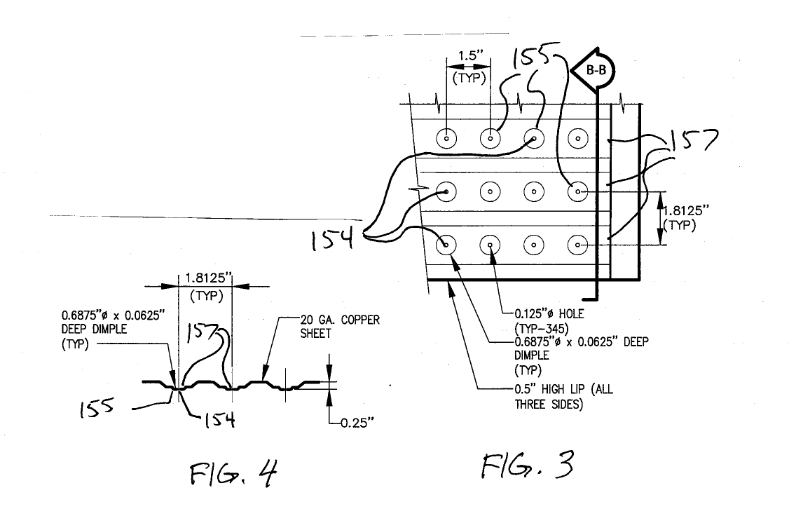

FIGS. 2 to 4 illustrate evaporative plate 153 in more detail. In some embodiments, the evaporative plate includes multiple holes therethrough distributed over the evaporative plate, and in some embodiments, the mixture of ethanol and water flows through the holes through the plate. In the embodiment illustrated, evaporative plate 153 includes multiple holes 154 (e.g., shown in FIG. 3) therethrough (i.e., through evaporative plate 153) distributed over the evaporative plate (e.g., as shown in FIG. 2). As used herein, holes being “distributed” over a plate means that the holes are substantially evenly spaced over at least half of the plate. Further, as used herein “substantially evenly spaced”, means spaced evenly to within plus or minus 50 percent of the median hole spacing. In different embodiments, the holes are substantially evenly spaced over at least 10, 20, 30, 40, 60, 70, 80, 90, or 95 percent of the plate, as other examples. Further, in different embodiments, holes are spaced evenly to within plus or minus 10, 20, 30, 40, 60, 70, 80, or 90 percent of the median hole spacing, as other examples. In the embodiment illustrated, the mixture of ethanol and water (e.g., from fermentation system 140 and located within tank 152 of distillation system 150) flows through holes 154 through evaporative plate 153.

Further, in some embodiments the evaporative plate includes multiple dimples, and in particular embodiments, each of the multiple holes is located in one of the dimples. In the embodiment illustrated, evaporative plate 153 includes multiple dimples 155. Further, in the embodiment shown, each of the multiple holes 154 is located in one of the dimples 155. In the embodiment illustrated, holes 154 are at the center of, and concentric within, dimples 155, for example. Further still, in a number of embodiments, holes, dimples, or both, are arranged in an array, in a grid pattern, are spaced apart from each other, or are substantially evenly space or evenly spaced (e.g., in one or in two directions) over the surface of the evaporative plate. As used herein “evenly spaced”, means spaced evenly to within plus or minus 25 percent of the median hole spacing. In the embodiment shown, holes 154 and dimples 155 are arranged in an array and in a grid pattern and are evenly spaced over the part of the surface of evaporative plate 153 that contains the holes and the dimples.

Even further, in some embodiments, multiple grooves or troughs in the evaporative plate distribute the ethanol and water mixture, for example, to the dimples, to the holes, or both. In the embodiment illustrated, parallel troughs 157 in evaporative plate 153 distribute the ethanol and water mixture to dimples 155 and to holes 154. In certain embodiments, the evaporative plate includes multiple troughs and the mixture of the ethanol and the water flows through the troughs across the evaporative plate. In the embodiment illustrated, for example, evaporative plate 153 has multiple troughs 157 and the mixture of the ethanol and the water flows through troughs 157 across evaporative plate 153.

Even further still, in some embodiments, the evaporative plate includes at least one centrally located opening through the evaporative plate and ethanol vapor flows through the centrally located opening through the evaporative plate. As show in FIG. 2, for example, evaporative plate 153 includes larger rectangular openings 156 arranged in a line at the center of evaporative plate 153. In a number of embodiments, these larger openings (e.g., 156) have at least 10, 20, 30, 40, 50, 60, 70, 80, 90, 100, 125, 150, 200, 250, 300, 400, 500, 700, or 1000 times more cross sectional area than holes 154, for example. In some embodiments, the at least one centrally located opening (e.g., 156) has a cross sectional area that is at least 10 times greater than a combined cross sectional area of the multiple holes (e.g., 154). In particular embodiments, the at least one centrally located opening (e.g., 156) has a cross sectional area that is at least 20, 30, 40, 50, 60, 70, 80, 90, 100, 125, 150, 200, 250, 300, 400, 500, 700, or 1000 times greater than the combined cross sectional area of the multiple holes (e.g., 154).

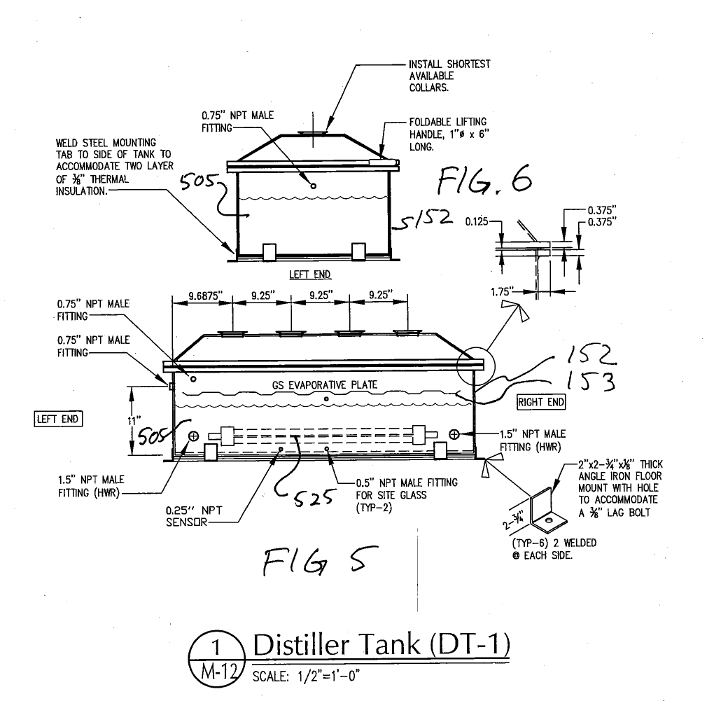

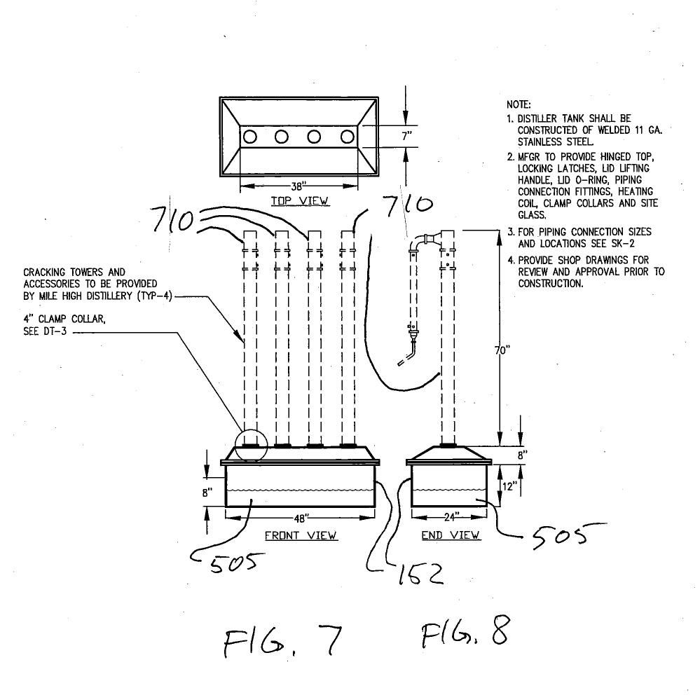

In the embodiment illustrated, openings 156 allow ethanol vapor evaporating below plate 153 to flow upwards to cracking towers (e.g., 710 shown in FIGS. 7 and 8) located above distillation tank 152 where the ethanol condenses. In the embodiment shown, the mixture of ethanol and water forms a pool (e.g., 505 shown in FIGS. 5-8) below evaporative plate 153, for example, after flowing or dripping through holes 154. Further, a heating coil (e.g., 525 shown in FIG. 5) within that pool (e.g., 505) heats the mixture of ethanol and water to the appropriate temperature to evaporate the ethanol without boiling the water so the ethanol will be separated from the water. In a number of embodiments, the heating coil (e.g., 525) is thermostatically controlled. In a number of embodiments, a recirculating pump delivers the mixture of ethanol and water from the pool (e.g., 505) below evaporative plate 153 to the top surface of evaporative plate 153. In the embodiment shown, evaporative plate 153 increases the amount of surface area of the mixture of ethanol and water which increases the rate at which the ethanol evaporates and separates from the water.

In some embodiments, the evaporative plate has a lip extending upward (e.g., ½ inch high), around the outside of the plate, for example, and the mixture of ethanol and water collect on the plate, within the lip, for instance, until passing through the holes (e.g., 154). Further, in a number of embodiments, the evaporative plate includes an angled or sloped surface (e.g., at an angle of 10, 20, 30, 40, 45, or 50 degrees from horizontal), for instance, at one end, that distributes the ethanol and water mixture onto the plate, for example, into troughs 157. Even further, in various embodiments, the evaporative plate (e.g., 153) is horizontal (e.g., other than dimples 155 and troughs 157) so that the mixture of ethanol and water collects on the evaporative plate (e.g., 153). Still further, in some embodiments, plate 153 is made of metal, for example, steel, stainless steel, aluminum, or copper. In other embodiments, plate 153 is made of plastic or ceramic. In some embodiments, a higher heat conductivity of plate 153 can be beneficial. In particular embodiments, for instance, plate 153 is made of copper.

Another example of an embodiment is an ethanol distillation unit that includes a distillation tank where the ethanol is separated from the water, and an evaporative plate located inside the distillation tank. In a number of embodiments, a mixture of the ethanol and the water is distributed over the evaporative plate. In the embodiment shown, distillation system 150 is an example of an ethanol distillation unit that includes distillation tank 152, where the ethanol is separated from water, and that also includes evaporative plate 153 located inside distillation tank 152. In the embodiment illustrated, as described, a mixture of the ethanol and the water is distributed over the evaporative plate (e.g., 153) to promote evaporation of the ethanol. Further, in the embodiment depicted, evaporative plate 153, as shown in FIGS. 2 and 3, includes multiple holes 154 therethrough distributed over evaporative plate 153. Further, in this particular embodiment, the mixture of the ethanol and the water flows through holes 154 through evaporative plate 153. Even further, in this embodiment, evaporative plate 153 includes multiple dimples 155 and each of the multiple holes 154 is located in one of the dimples 155.

In the embodiment illustrated, the ethanol distillation unit, or distillation system 150, is located and operated within shipping container 110. Other embodiments, however, may differ. Further, in some embodiments, the ethanol distillation unit (e.g., modular distillation unit 100, including or not including shipping container 110) further includes at least one feedstock storage tank (e.g., 121 and 122), a mixing chamber (e.g., 130) that mixes the feedstock and water to create a feeder mixture with a predetermined ratio of the feedstock and the water, and a fermentation system (e.g., 140). In the embodiment illustrated, fermentation system 140 ferments the feeder mixture and includes at least one fermentation tank (e.g., 141 and 142). In the embodiment depicted, fermentation system 140 outputs the mixture of the ethanol and the water to distillation tank 152 where the ethanol is separated from water.

Further, in some embodiments, including the embodiment shown, the ethanol distillation unit (e.g., modular distillation unit 100, including or not including shipping container 110) further includes pasteurization system 160 that cleans fermentation system 140. Even further, in certain embodiments, the evaporative plate (e.g., 153) includes multiple holes (e.g., 154) therethrough multiple dimples (e.g., 155), or both. In some embodiments each of the multiple holes 154 is located in (e.g., the center) of one of the dimples 155. As shown, in some embodiments the ethanol distillation unit (e.g., as just described) is located and operated, for example, within a shipping container (e.g., 110).

In some embodiments, the ethanol is used to power an engine, such as an internal combustion engine or an external combustion engine (e.g., a Stirling engine). In the embodiment shown, distillation system 150 provides ethanol to engine 180 located in shipping container 111. In other embodiments, the engine may be located in the same shipping container (e.g., 110) as distillation system 150. In some embodiments, the engine (e.g., 180) may drive a generator, which may generate electricity, for example, for local use (e.g., associated with modular distillation unit 100) or for surrounding areas.

Yet another example of an embodiment is a mixing device (e.g., 130) for a feedstock and a liquid. Further, in some embodiments, the mixing device includes a chamber that includes a first input for the feedstock, a second input for the liquid (e.g., water), and an output for a mixture of the feedstock and the liquid. In the embodiment shown, for example, mixing device 130 includes chamber 133 that includes first input 131 for the feedstock, second input 132 for the liquid (e.g., water), and output 134 for a mixture of the feedstock and the liquid. In this embodiment, mixing device 130 further includes mixing section 136 coupled to first input 131, second input 132, and output 134, and (e.g., metal) mixing medium 137 located inside mixing section 136. In some embodiments, the (e.g., metal) mixing medium (e.g., 137) includes (e.g., at least one of) a stainless steel scrubber, steel wool, copper wool, brass wool, another metallic wool or scrubber, or a combination thereof, as examples.

Still other embodiments include various methods of creating ethanol from feedstock. In some embodiments, for example, the method includes storing feedstock in one or more storage tanks (e.g., 121, 122, or both), mixing in a mixing chamber (e.g., 133) the feedstock and water into a feeder mixture a with predetermined ratio of feedstock and water, fermenting in one or more fermentation tanks (e.g., 141, 142, or both) the feeder mixture into a fermentation mixture, and distilling the ethanol in a distillation system (e.g., 150) from the fermentation mixture. In some embodiments the one or more storage tanks (e.g., 121, 122, or both), the mixing chamber (e.g., 133), the one or more fermentation tanks (e.g., 141, 142, or both), the distillation system (e.g., 150), or a combination thereof, are located inside of two shipping containers (e.g., 110 and 111) that are mechanically coupled to each other (e.g., with fasteners 112 and 113). Still other embodiments include various methods of producing fuel. Such a method can include, for example, distilling ethanol from a feedstock within two shipping containers (e.g., 110 and 111). Further, in some embodiments, such a method can include, for example, distilling ethanol from a feedstock within one shipping containers (e.g., 110). Yet another embodiments is a modular distillation unit (e.g., 100) that includes a system located inside of a two shipping containers (e.g., 110 and 111), that are mechanically coupled to each other (e.g., with fasteners 112 and 113) and configured to produce ethanol from a feedstock.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale, although the relative sizes illustrated may provide an example of relative sizes of different components. But in some cases, the dimensions of some of the elements in the figures may be exaggerated relative to other elements, for example, to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used may convey information about the different embodiments, but may be interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi permanent or only for an instant.

“Electrical coupling” and the like should be broadly understood and include coupling involving any electrical power or signal, whether a power supply, a data signal, and/or other types or combinations of electrical power or signals. “Mechanical coupling” and the like should be broadly understood and include mechanical coupling of all types. Further, the absence of the word “removably,” “removable,” and the like near the word “coupled,” and the like does not mean that the coupling, etc. in question is or is not removable.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that many activities and elements described herein may be comprised of many different activities, procedures and be performed by many different modules, in many different orders that any element of drawings may be modified and that the foregoing discussion of certain of these embodiments does not necessarily represent a complete description of all possible embodiments.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

Various embodiments of the subject matter described herein include various combinations of the acts, structure, components, and features described herein, shown in the drawings, or known in the art. Moreover, certain procedures may include acts such as obtaining or providing various structural components described herein, obtaining or providing components that perform functions described herein. Furthermore, various embodiments include advertising and selling products that perform functions described herein, that contain structure described herein, or that include instructions to perform functions described herein, as examples. Such products may be obtained or provided through distributors, dealers, or over the Internet, for instance. The subject matter described herein also includes various means for accomplishing the various functions or acts described herein or apparent from the structure and acts described.

What is claimed is:

1. A modular distillation unit comprising:
one or more shipping containers;
one or more storage tanks located inside the one or more shipping containers and configured to a hold feedstock;
a mixing chamber located inside the one or more shipping containers and coupled to the one or more storage tanks, the mixing chamber configured to mix the feedstock and water to create a feeder mixture with a predetermined ratio of the feedstock and the water;
a fermentation system located inside the one or more shipping containers and configured to ferment the feeder mixture, the fermentation system comprising one or more fermentation tanks; and
a distillation system located inside the one or more shipping containers and coupled to the fermentation system and configured to distill ethanol from an output of the fermentation system.

2. The modular distillation unit of claim 1 wherein the distillation system comprises a distillation tank and an evaporative plate located inside the distillation tank, and wherein a mixture of ethanol and water is distributed over the evaporative plate.

3. The modular distillation unit of claim 2 wherein the evaporative plate comprises multiple holes therethrough distributed over the evaporative plate, and wherein the mixture of ethanol and water flows through the holes through the evaporative plate.

4. The modular distillation unit of claim 3 wherein the evaporative plate comprises multiple dimples and wherein each of the multiple holes is located in one of the dimples.

5. The modular distillation unit of claim 1, further comprising: a pasteurization system located inside the one or more shipping containers and configured to be used to clean the fermentation system.

6. The modular distillation unit of claim 1, further comprising: one or more installation rails coupled to at least one of the one or more shipping containers and removably couplable to the one or more storage tanks to couple the one or more storage tanks to the at least one of the one or more shipping containers.

7. The modular distillation unit of claim 1, wherein: each of the one or more shipping containers is a 40 feet long by 8 feet wide steel shipping container.

8. The modular distillation unit of claim 1, wherein: the mixing chamber comprises a metal mixing medium located inside the mixing chamber.

9. The mixing device of claim 8, wherein: the metal mixing medium comprises at least one of a stainless steel scrubber, steel wool, copper wool, brass wool or another metallic wool or scrubber.

10. An ethanol distillation unit comprising:
a distillation tank where the ethanol is separated from water; and
an evaporative plate located inside the distillation tank;
wherein a mixture of the ethanol and the water is distributed over the evaporative plate.

11. The ethanol distillation unit of claim 10 wherein the evaporative plate comprises multiple holes therethrough distributed over the evaporative plate and wherein the mixture of the ethanol and the water flows through the holes through the evaporative plate.

12. The ethanol distillation unit of claim 11 wherein the evaporative plate comprises at least one centrally located opening through the evaporative plate and wherein ethanol vapor flows through the at least one centrally located opening through the evaporative plate, and wherein the at least one centrally located opening has a cross sectional area that is at least 10 times greater than a combined cross sectional area of the multiple holes.

13. The ethanol distillation unit of claim 11 wherein the evaporative plate comprises multiple dimples and wherein each of the multiple holes is located in one of the dimples.

14. The ethanol distillation unit of claim 10 wherein the ethanol distillation unit is located and operated within a shipping container.

15. The ethanol distillation unit of claim 10 further comprising:
at least one feedstock storage tank;
a mixing chamber that mixes the feedstock and water to create a feeder mixture with a predetermined ratio of the feedstock and the water; and
a fermentation system that ferments the feeder mixture, the fermentation system comprising at least one fermentation tank, wherein the fermentation system outputs the mixture of the ethanol and the water to the distillation tank where the ethanol is separated from water.

16. The ethanol distillation unit of claim 15 further comprising a pasteurization system that cleans the fermentation system.

17. The ethanol distillation unit of claim 15 wherein the evaporative plate comprises multiple holes therethrough distributed over the evaporative plate and wherein the mixture of the ethanol and the water flows through the holes through the evaporative plate.

18. The ethanol distillation unit of claim 17 wherein the evaporative plate comprises multiple dimples and wherein each of the multiple holes is located in one of the dimples.

19. The ethanol distillation unit of claim 15 wherein the ethanol distillation unit is located and operated within a shipping container.

20. The ethanol distillation unit of claim 10 wherein the evaporative plate comprises multiple troughs and wherein the mixture of the ethanol and the water flows through the troughs across the evaporative plate.
